(19) United States
(12) Patent Application Publication
(10) Pub. No.: US 2012/0141971 A1
(43) Pub. Date: Jun. 7, 2012

(54) SYSTEMS AND METHODS FOR REMOTE ACCESS TO TREATMENT PLANS

(76) Inventor: Doreen Granpeesheh, Woodland Hills, CA (US)

(21) Appl. No.: 13/396,424

(22) Filed: Feb. 14, 2012

Related U.S. Application Data
(63) Continuation-in-part of application No. 12/874,159, filed on Sep. 1, 2010.

(51) Int. Cl. G09B 7/00

(52) U.S. Cl. 434/362

(57) ABSTRACT

Computer-based methods and systems for providing individuals access to automatically generated and individualized ABA-based programs of instruction based on the needs of children with developmental disorders. Such access is provided via applications (“apps”) deployed to mobile computing platforms (e.g., smart phones, table computers, and the like). Thus, behavioral educators of children with developmental disorders, parents of and care givers for said children, as well as said children themselves, all may have access to aspects of the instruction programs.

### RELATED APPLICATIONS

This application is a CONTINUATION-IN-PART of U.S. patent application Ser. No. 12/874,159, filed 1 Sep. 2010, which is assigned to the assignee of the present invention and incorporated herein by reference.

### FIELD OF THE INVENTION

The present invention relates to computer-based methods and systems for providing behavioral educators of children with developmental disorders, parents of and care givers for said children and said children themselves, access to automatically generated and individualized ABA-based programs of instruction based on the needs of said children via applications deployed to mobile computing platforms.

### BACKGROUND

Applied behavior analysis (ABA) can be regarded as the application of behaviorism, the study of human behavior, to affect, enhance or eliminate a particular behavior in an individual. ABA has been used in connection with a variety of activities, including teaching children with developmental disorders, such as autism. ABA is not, however, a specific program or curriculum for teaching an autistic child desired skills; rather, it is a framework for understanding how an appropriate program can be developed.

In the above-cited U.S. Patent Application, a computer-based system for child development assessment and development of individualized treatment plans was described. The system provides assessment tools for behavioral educators of children with developmental disorders to identify mastered and non-mastered skills of a subject child and treatment plan modules to permit the behavioral educator to determine a set of lessons from a curriculum for the subject child. The lessons define an individualized, ABA-based program of instruction based on the needs of a subject child as identified by the assessment tools. Progress charts are made available to permit monitoring of the subject child's progress as he/she progresses through the lessons of the individualized program under the guidance of one or more instructors. Thus, the system provides strong correlation between skill assessment and a teaching curriculum.

### BRIEF DESCRIPTION OF THE DRAWINGS

The present invention is illustrated by way of example, and not limitation, in the figures of the accompanying drawings in which:

FIG. 1 illustrates an example of a computer network in which embodiments of the present invention may find application and use;

FIG. 2 illustrates an example of a computer system suitable for configuration in accordance with embodiments of the present invention;

FIG. 3 illustrates a software architecture of a computer system configured in accordance with an embodiment of the present invention;

FIGS. 4-8 illustrate examples of user interface screens for an activity in the form of a game to be presented via a mobile device in accordance with embodiments of the present invention;

FIGS. 9-11 illustrate alternatives for implementing prompt-response colloquies within a game in accordance with embodiments of the present invention;

FIG. 12 illustrates options for providing rewards at various stages of game playing in accordance with embodiments of the present invention; and

FIG. 13 illustrates an overview of a process for downloading, installing and using applications configured in accordance with embodiments of the present invention on mobile devices.

### DETAILED DESCRIPTION

Described herein are computer-based methods and systems for providing individuals access to automatically generated and individualized ABA-based programs of instruction based on the needs of children with developmental disorders. In particular embodiments of the invention, such access is provided via applications (“apps”) deployed to mobile computing platforms (e.g., smart phones, table computers, and the like). Thus, behavioral educators of children with developmental disorders, parents of and care givers for said children and said children themselves all may have access to aspects of the instruction programs.

For example, educators, parents and care givers may have access to activities which are part of a larger, individualized lesson plans and which are designed to teach particular skills to a subject child. Alternatively, or in addition, children may have access to games or similar interactive, skill-teaching modules, which act as a proxy for a human educator and provide instruction. The mobile platform applications are preferably communicatively coupled to a remote system (e.g., via wireless networking capabilities of the mobile platform), thereby to report progress information concerning the subject child's mastery (or not) of the target skill set of the activity to the remote platform, where such information can be monitored, assessed and provided for review by the child's educators, parents and/or care givers. The remote platform may also upload additional activities to the mobile platform based on the child's progress (or lack thereof) at mastering the target skill set. Communications between the mobile platforms (and applications running thereon) and the remote platform at which a computer-based system for child development assessment and development of individualized treatment plans is hosted may be periodic in nature (e.g., as is often the case in client-server environments), allowing the mobile applications to run “untethered”. Reports from the mobile applications to the remote platform and uploads from the remote platform to the mobile device may occur as and when communications are available, at scheduled intervals, and/or according to user-defined criteria and/or direction. These and further features of the present invention will be described in greater detail below.

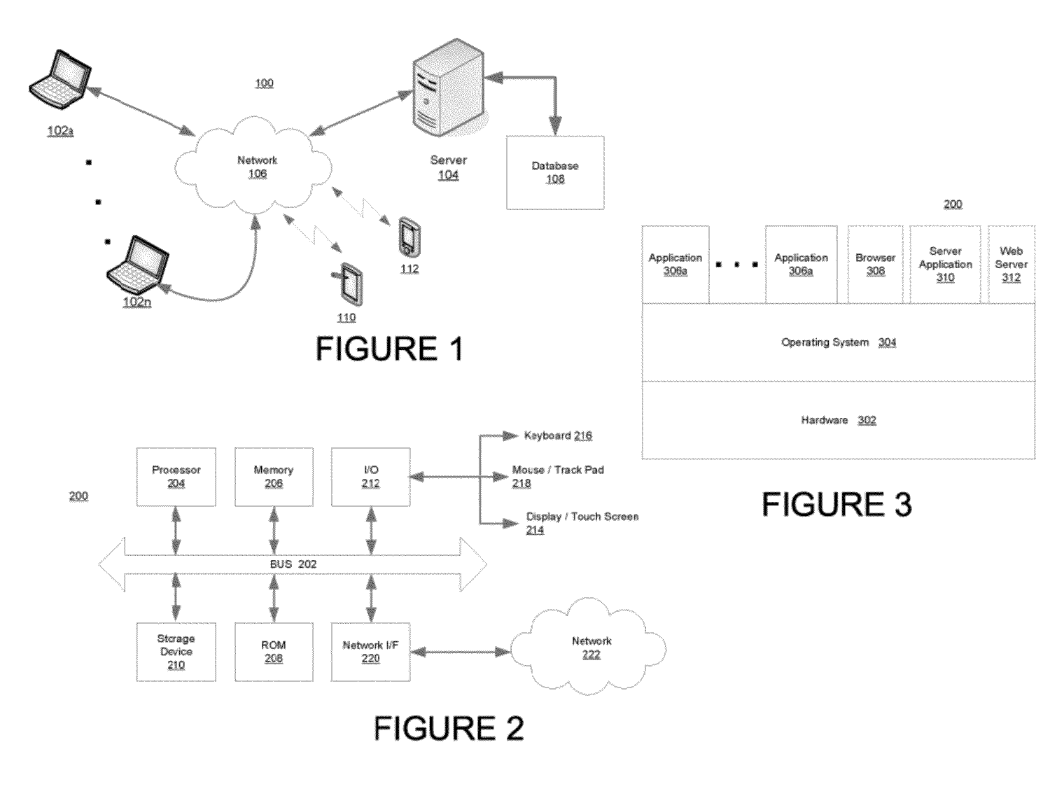

Before describing aspects of the present invention in detail, however, it is helpful to first discuss the environment in which embodiments of the invention operate. FIG. 1 is a simplified illustration of a computer network 100, which is such an environment. Network 100 includes one or more client computer systems 102a-102n, which may be used by educators and others seeking to access a server 104 at which an instantiation of a computer-based system for child development assessment and development of individualized treatment plans as described in the above-cited U.S. Patent Application may be installed and accessible. Such access may be over a computer network or network of networks 106, such as a local and/or wide area network. In some cases, network 106 may be or include the network of networks commonly known as the Internet. In other instances, network 106 may be a local area network (LAN) of an enterprise and/or a virtual LAN that is instantiated over the Internet or other networks of networks.

Server 104 is communicatively coupled to a database 108, which may store records concerning children for which curricula have been developed, mobile applications for uploading to client devices, and other information as described further below. Client computers 102a-102n may be any form of computer-based system, including personal computers, laptop computers, net book computers, mobile devices, and the like. Further examples of client computers are tablet computer 110 (e.g., an iPad™ device made by Apple, Inc., or a tablet computer running the Android™ operating system available from Google, Inc., etc.) and smart phone 112 (e.g., an iPhone™ made by Apple, Inc., or a smart phone running the Android operating system, etc.).

Generally, a client 102 will run a Web browser application, through which the application running on server 104 may be accessed, however, in some instances, client computers 102 may run a client application specially configured to interface with the application running on server 104. For example, tablet computer 110 and smart phone 112 may each configured with instantiations of applications (“apps”) specially designed for such interaction with the application running on server 104 to provide individuals (e.g., educators, parents and care givers, and children) access to automatically generated and individualized ABA-based programs of instruction. In this way, activities, which are part of a larger, individualized lesson plans and which are designed to teach particular skills to a subject child, can be downloaded to the tablet computer and/or smart phone for use by the educator, parent, care giver and/or child without the need to participate in an on-line session with the server 104. Such content (i.e., the activities) may be instantiated as games or similar interactive, skill-teaching modules which, when played by the subject child, act as a proxy for a human educator and provide instruction. The child's success or failures when playing the game are recorded and can be downloaded from the client/tablet computer/smart phone to the server 104 (i.e., the application running thereon) either as the game is being played or during a subsequent communication session between the mobile device and the server. Alternatively, or in addition, when used by the educator, parent and/or caregiver, the content may provide instruction to that individual as to how to teach the desired skill to the child (e.g., in the form of a portion of a lesson plan or similar tutorial). Facilities are also provided for the educator, parent and/or care giver to record the child's successes and failures concerning mastery of the target skill set and that information can be downloaded from the client/tablet computer/smart phone to the server 104 (i.e., the application running thereon) either as the instruction is being conducted or during a subsequent communication session between the mobile device and the server.

FIG. 2 is a block diagram illustrating an example of a computer system 200. Any of client computer systems 102a-102n, 110, 112, and/or server 104 may be configured in the manner described for computer system 200.

Computer system 200 includes a bus 202 or other communication mechanism for communicating information, and a processor 204 coupled with the bus 202 for processing information. Computer system 200 also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to the bus 202 for storing static information and instructions for the processor 204. A computer-readable storage device 210, such as a flash drive, magnetic disk or optical disk, is provided and coupled to the bus 202 for storing information and instructions.

Computer system 200 may be coupled via the bus 202, either directly or via an input/output module 212, to a display 214, such as a flat panel display or touch screen, for displaying information to a computer user. An input device, such as a keyboard 216, including alphanumeric and other keys, may be coupled to the bus 202 for communicating information and command selections to the processor 204 (although in some cases, the keyboard used by computer system 200 may be a virtual keypad presented to a user via display 214). Another type of user input device is cursor controller 218, such as a mouse, a trackball, a track pad, or cursor direction keys for communicating direction information and command selections to processor 204 and for controlling cursor movement on the display 214.

As should be apparent, aspects of the present invention may involve computer software running on server 104, and/or clients 102a-102n, 110 and/or 112. That software may take the form of computer-executable instructions stored in main memory 206 and/or storage device 210, to be executed by processor 204. In other instances, the instructions may be stored on other computer-readable media, such as a floppy disk, a flexible disk, a hard disk, magnetic tape, or any other magnetic medium, a CD-ROM or DVD-ROM, flash memory, or any other physical medium adapted to store computer-readable instruction and from which a computer processor can read. Execution of the sequences of instructions contained in the main memory 206 causes the processor 204 to perform the processes described herein, in particular to provide the apps discussed in greater detail below.

Computer system 200 also includes a network interface 220 coupled to the bus 202. Network interface 220 provides a two-way data communication path for computer system 200 to/from a network 222. For example, network interface 220 may be a modem to provide a data communication connection to a corresponding type of telephone line, a network (e.g., Ethernet) interface to provide a data communication connection to a compatible local area network (LAN) or other network, and/or a wireless communication interface, such as is compatible with wireless LANs, mobile phone networks or other wireless communication networks. In any such implementation, network interface 220 sends and receives electrical, electromagnetic or optical signals that carry digital data streams representing various types of information. In one embodiment, network 222 may be network 106, or may be communicatively coupled thereto.

FIG. 3 shows an architectural view of computer system 200. The various hardware components of computer system 200 are represented as a hardware layer 302. An operating system 304 abstracts the hardware layer and acts as a host for various applications 306a-306m, that run on computer system 200, for example, in the case of a smart phone or tablet computer, the apps discussed herein to provide individuals access to ABA-based programs of instruction based on the needs of children with developmental disorders. Alternatively, or in addition, in the case of a client computer system the operating system may act as a host for a Web browser application 308. In the case of the server 104, the operating system acts as a host for a server application 310 configured to provide training materials, on-line assessment tools, and/or individualized curricula responsive to requests and other information received from a client computer system, and, in some instances, to provide applications (or content therefor) to clients 102a-102n, tablet computers 110 and/or smart phones 112. For the server 104, the operating system may also host a web server application 312, which provides access from the client computers via web browsers. In other instances, the web server may be hosted on a separate server (not shown in detail), which is communicatively coupled to a server hosting application 310.

As discussed in detail in the above-referenced U.S. Patent Application, server 104 hosts a software package for providing behavioral educators of individuals (e.g., children) with developmental disorders: (a) training in ABA and how it is used to teach skills to said individuals, (b) on-line assessment tools to identify mastered and non-mastered skills of said individuals, and (c) automatically generated and individualized ABA-based programs of instruction based on the needs of said individuals as identified through use of the assessment tools. Through the use of an assessment tool, individualized, ABA-based instruction programs are created and made accessible to educators, therapists, parents, physicians, and others involved with the subject children for which the programs are intended. The programs include on-line training modules that can be used by the behavioral educator to teach identified skills to the subject individual. The curriculum from which the programs are derived includes several different areas, including language, play, adaptive, motor, executive functions, cognition, social, and academic skills, and each program is composed of lessons developed to give the behavioral educator examples of specific concepts that should be taught.

The present invention expands the reach of the previously described system by providing for individual activities, which collectively make up lessons of the instruction program, to be delivered to remote devices (such as clients 102a-102n, tablet computer 110 and/or smart phone 112), where they can be used. In addition to activities in support of a lesson, content such as training and education material may likewise be delivered to the mobile devices. These materials may provide training in ABA and its use in developing programs to teach skills to children with developmental disorders. Topics of such educational materials may include:
Autism and how it is diagnosed,
Introduction to ABA and its principles,
Assessment and identification of skill targets,
Teaching Paradigms, including:
   Natural Environment Training (NET),
   Discrete Trial Training (DTT),
   Fluency-Based Instruction (FBI),
Procedures discrimination training, including:
   Prompting and Fading (prompts are generally regarded as cues to encourage a desired response from an individual, and may be categorized from most intrusive to least intrusive, with a goal of teaching desired behavior to be systematic fading of prompt methods towards independence),
   Shaping (the gradual modification of existing behavior into desired behavior),
   Chaining (linking of incremental activities to be learned in order to achieve an overall desired skill),
Generalization and Maintenance (the expansion of a child's performance abilities beyond the initial conditions set for acquisition of a skill),
Functional behavioral assessment (FBA) (e.g., assessment of types and sources of reinforcement for challenging behaviors to be as the basis for intervention efforts designed to decrease the occurrence of these behaviors),
Interventions for challenging behavior (challenging behaviors are generally those which are culturally abnormal and are of such intensity, frequency or duration that the physical safety of the subject individual or others is placed in serious jeopardy, or behavior which is likely to seriously limit or deny access to the use of ordinary community facilities), and
Data collection, etc.
   The materials may be provided in any convenient fashion, for example as documents, audio-video presentations, interactive workbooks, etc. In some instances, the materials may be provided as part of a certification program or other formal course of instruction.

When downloaded as applications to a mobile device (e.g., either by server 104 or from a source such as Apple, Inc.'s App Store™ or other source of applications for mobile devices), the activities may be related to a lesson of a treatment plan or may be a la carte selections made by an instructor, care giver, parent or other person. In some cases these activities may provide instruction to an instructor, care giver or other (e.g., in the form of an audio-video presentation and/or text) in how to properly conduct and present the lesson to the subject individual in a manner appropriate for a child with developmental disabilities. Alternatively, or in addition, the activities may provide games or other tools for the developmentally disabled person to interact with. In this way, the game serves as a proxy for an instructor, presenting materials and invoking responses in the manner prescribed by ABA principles to help the subject developmentally disabled person develop the skill that is the subject of the activity.

By way of non-limiting example, assume that the skill to be developed relates to the subject individual's ability (or inability) to match an object to others from a selected set. The activity downloaded to the mobile device may include instructions for a therapist, care giver or other person in teaching the skill. For example, the instructions may read:
S^{D}: The therapist presents a field of comparison objects, hands the child a sample object, and presents the vocal stimulus, “Put with same”.
   The activity would also include a target response from the subject child:
R: The child matches the sample object to an identical object in the field.
   A further example may instruct the therapist to create a situation where a child indicates a desire for an object:
EO: The child is deprived of a desired object.
S^{D}: The therapist contrives a situation that evokes the child to mand for a desired object.
   Here, the target response is:
R: “More” or “More (object)” or “(Object)” or “I want (object),” with/without a gesture toward the desired object.
   (A mand is a form of verbal behavior that is controlled by deprivation, satiation, or what is now called motivating operations (MO), as well as a controlling history.)

In other cases, the activity may specify a set up; for example:
Setup: Present a field of pictures of locations for the child to view when giving his/her response.
S^{D}: “Where do you go to (action)?”
R: “A/An/The (room/location).”

Alternatively, or in addition, when the activity is to be performed by the child alone, using the mobile device, the application may run in a mode where it stands in as a proxy for the therapist. For example, for a child who cannot point, the SD “Touch (object)” could be manifest by the application using text or synthetic voice commands instructing the child to touch the designated object as it is displayed on the screen of the mobile device. In each instance, the child's responses are recorded (e.g., along with the time to complete an activity, the correctness or incorrectness of a response, etc.) for later download to the server 104.

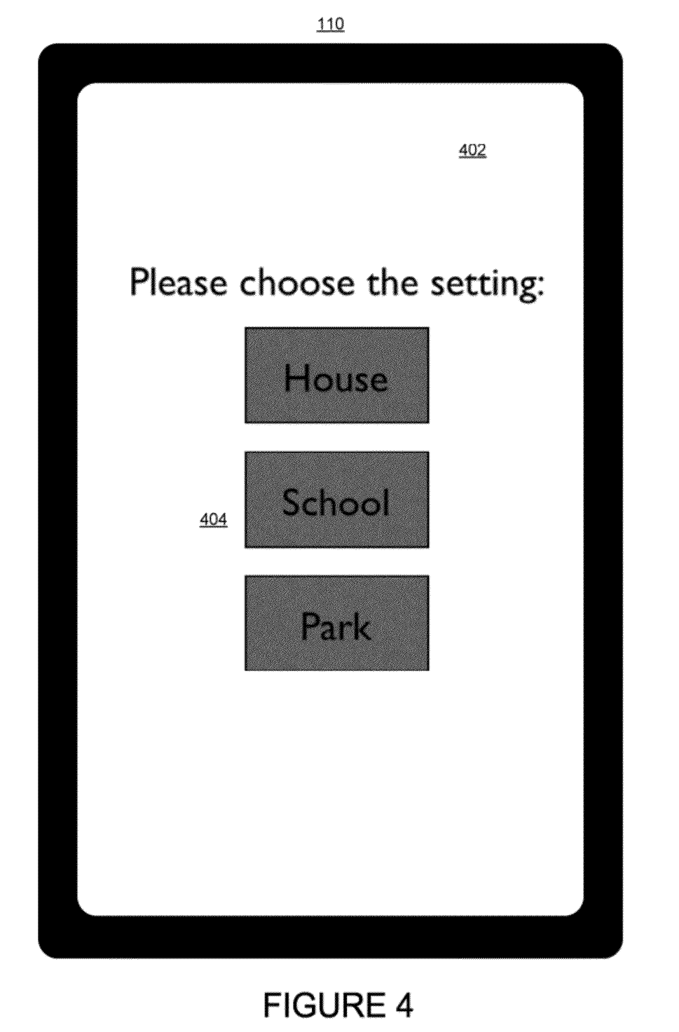

An example of an activity in the form of a game to be presented via a mobile device in accordance with embodiments of the present invention is illustrated through the use of user interface screens shown in FIGS. 4-8. These screens may be presented to the child via a display screen 402 of a mobile device, such as a tablet computer 110. Of course, any of the mobile devices discussed herein could be used and the screens presented in conjunction with this description are intended only to illustrate one kind of activity which may be performed using the game-like metaphor for self-directed actions of a child or other individual. The use of these examples should not be read as somehow limiting the scope of the present invention.

In the context of FIGS. 4-8, the idea behind the application is to use images of real-world environments to help a child identify typical household furniture, appliances and other items that he/she may encounter in his/her daily life. When a child learns various objects receptively, as through the use of such an application, he/she will learn to generalize these objects around the house. In the present application, when instructed to “find the book”, or some other article or item, the child should recognize that he/she needs to scroll through images of different rooms of the house looking for the book. For example, a book may likely be found on a bookshelf, say in a home office. Thus, the goal is to have the child scroll through images of the house, searching for the home office, and then locate a book within that room. By touching the display screen in the vicinity of an image of a book when it appears on the screen, the child can be considered as having “won”. Through multiple such interactions, the child learns to generalize across stimuli (e.g., “window” can be a small window in bedroom or large window in living room), as well as across settings. Ideally, at basic levels of this game there should only be one unique object within all rooms of the specified setting (e.g., only 1 television in a house, which is found in the living room) so as to allow the child to begin to develop the skills that are targeted. Over time, as the child is determined to have mastered certain skills, difficulty and complexity of the game may be increased (e.g., by uploading different versions thereof from the server), so that the child can further develop these skills. During a game session, as the child finds each requested object, a new search for a new object is directed.

In FIG. 4, an initial screen 404 seeks user input as to the kind of setting, a house, school or park, desired. Different objects are commonly found in different settings, so this helps to orient the game activity for the desired context. The child or an assistant may make the necessary selection. Of course, in other instances separate games may be provided for each different setting, making such a selection unnecessary. Alternatively, or in addition, a game setting may be specified (e.g., beginner, intermediate, advanced, etc.), in order to determine the complexity of the tasks and/or the settings for the game.

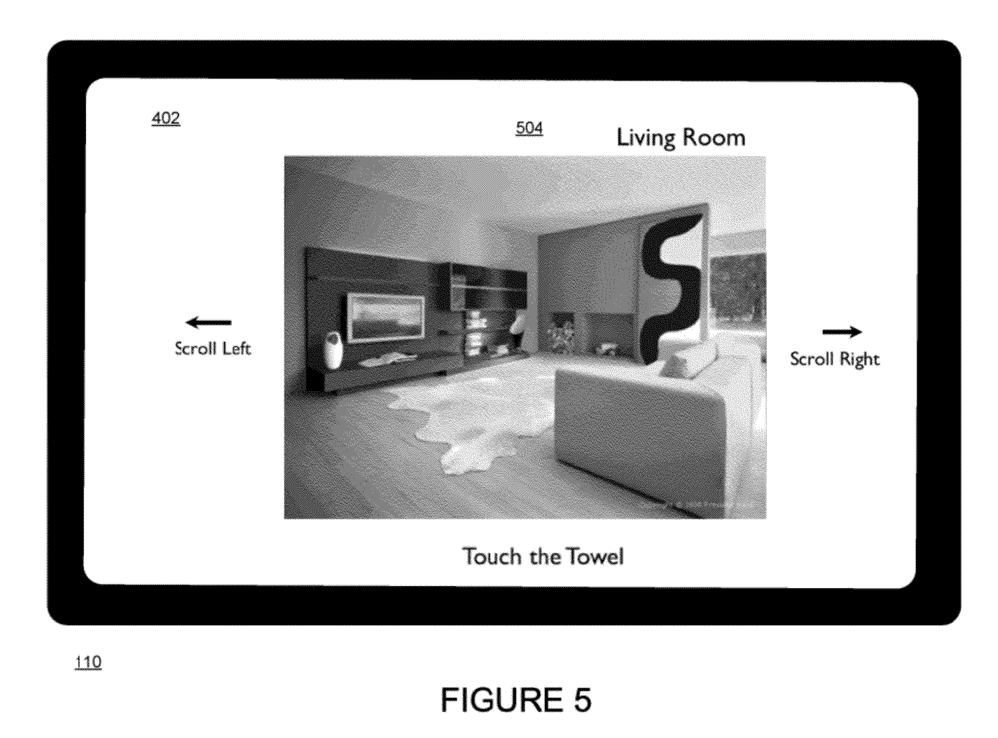

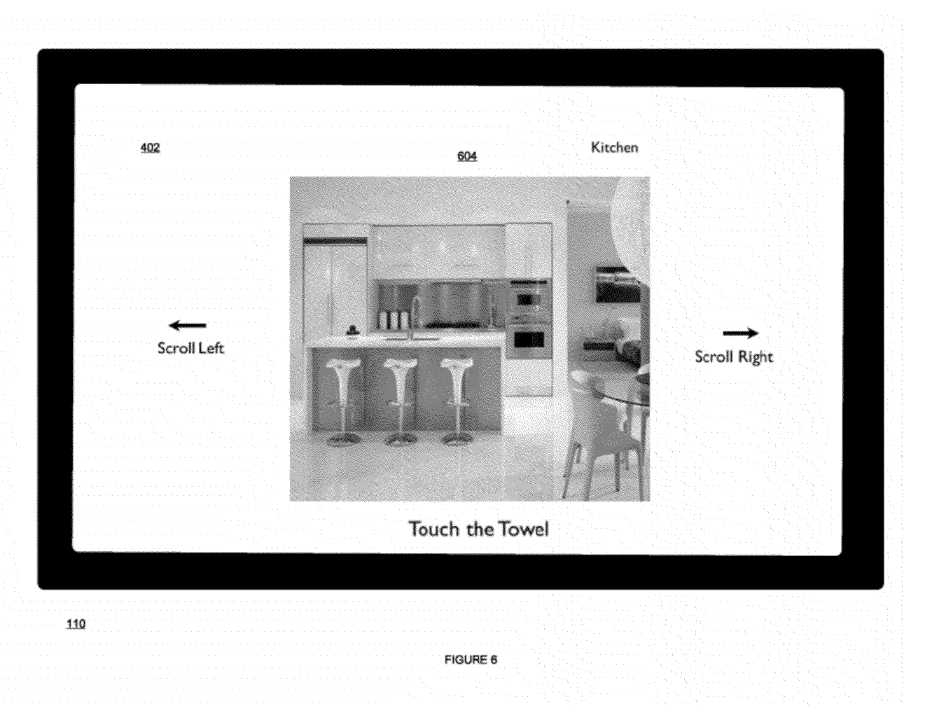

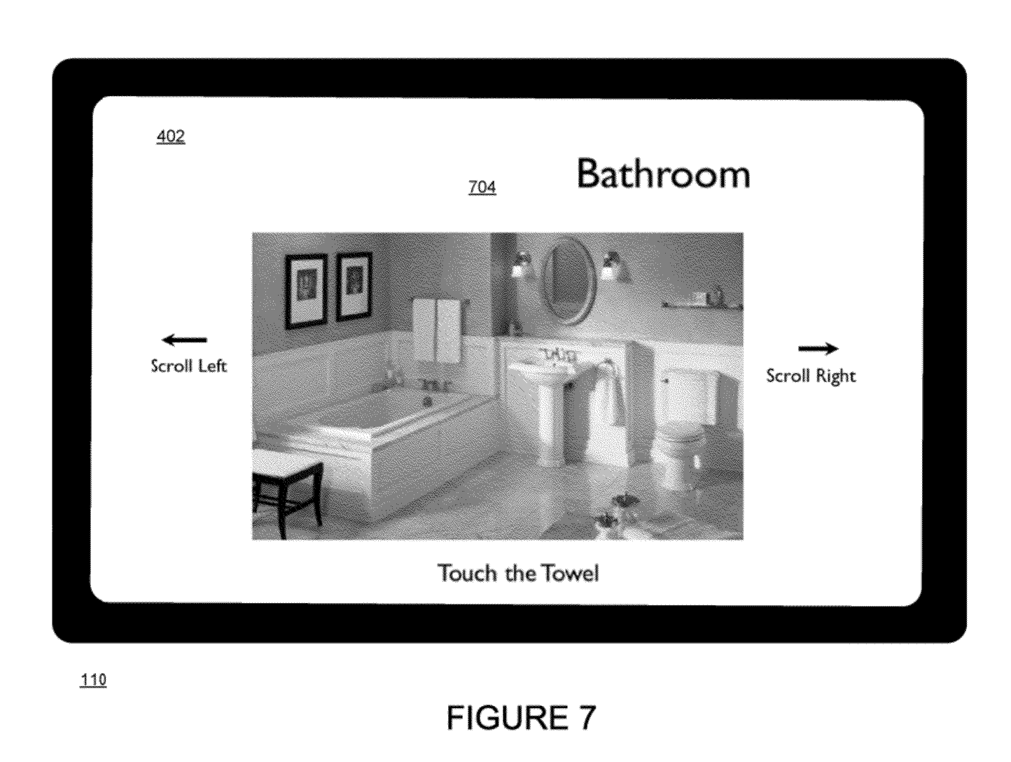

In this example, it is assumed that a house setting is selected and the child is presented with his/her first task, “Touch the Towel”. The command may be presented on the screen and/or played audibly. FIG. 5 shows the first in a series of images of the house, this one being of the living room 504, and the child is expected to scroll through the images looking for a towel. Since there is no towel in the living room, the child scrolls to the next room, which as shown in FIG. 6 may be the kitchen, as represented by image 604. Once again, no towel is present so the child is expected to scroll to the next room, which as shown in FIG. 7 may be the bathroom, as represented by image 704.

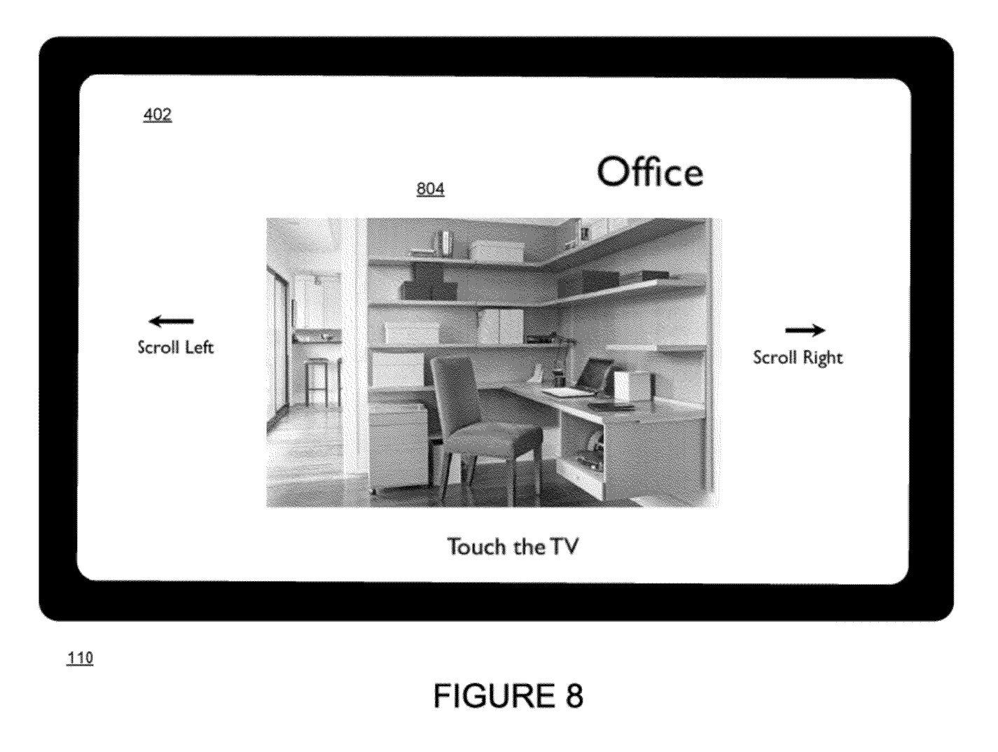

Notice that a towel is present in the bathroom and so the child would be expected to touch screen 402 in the vicinity of the towel in image 704. Correct identification of the towel can be recorded and later used to update the child's profile at the server. The time taken to complete the task, the number of incorrect attempts (if any) and other statistics may also be recorded. Once the child has correctly completed the task, the game moves on to the next task, in this example “Find the TV”, as shown in FIG. 8 and the image 804 is updated to reflect another room in the house.

To “win” the game, the child may be required to successfully identify generalized objects across multiple different settings. Sets of items should be comprised of objects that are found throughout the house (or other selected setting). When the child identifies the set of given objects without making any errors in that trial set, the child has “won”. Finding all of the items in each of multiple levels without selecting any incorrect items may demonstrate mastery of the desired skill.

Other applications (games) may include images or scenes rendered with three-dimensional (3D) effects or technologies. For example, layering objects on top of one another within a field so as to provide an illusion of depth within the image or scene. Such 3D renderings will provide perspectives that two-dimensional (2D) images do not and can be useful when teaching motor skills to users. For example, rotating 3D images can allow the child to view a room or other environment from different angles, testing abilities in cognitive perception, fine motor skills and so on.

In the above examples and in the context of an instructional program, in order to teach a set of skills to a child an instructor (or, by proxy, the game) introduces a set of discriminative stimuli and/or establishing operations (EO). Each discriminative stimulus (S^{D}) is, typically, an instruction or request to which the instructor (game) would like the child to respond (R) (e.g., by exhibiting a particular behavior). An EO is an environmental event that affects the child by momentarily altering (a) the reinforcing effectiveness of other events and (b) the frequency of occurrence of that part of the child's repertoire relevant to those events as consequences. Both EOs and S^{D}s are intended to evoke behavioral responses in the child.

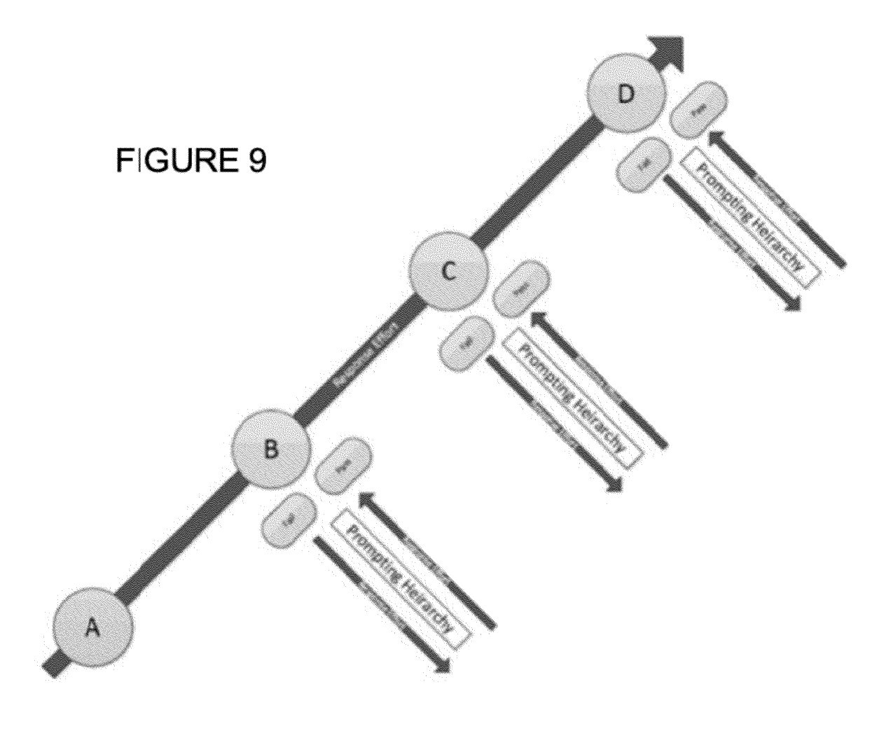

The architecture of the game environment is further illustrated in FIG. 9. Each game or lesson may be considered as a series of steps, each building off of the last successfully completed one in terms of its complexity and effort. In the illustration, a game is comprised of steps A-D, etc. Progession along the game path from A to B to C, etc., involves incrementally more effort from the child in order to provide correct responses. Also, at each step, the prompt-response colloquy begins at a determined level but adjusts if the child provides incorrect answers. That is, at each step A, B, C, etc., the prompt-response nature of the game (e.g., where a prompt may be to “Touch the Towel” and the response is correctly identifying the towel in a series of images), is adjusted (made easier or more difficult), depending on the nature and character of the child's responses. For example, if a child takes a long time to enter a response to a current prompt and the response is incorrect, the next prompt may be adjusted to an easier task. Alternatively, if the child answers a current prompt quickly and correctly, the next prompt may be made progressively harder. This continues at each step until overall the child demonstrates he/she has mastered the desired skill, and the game then moves on to the next step.

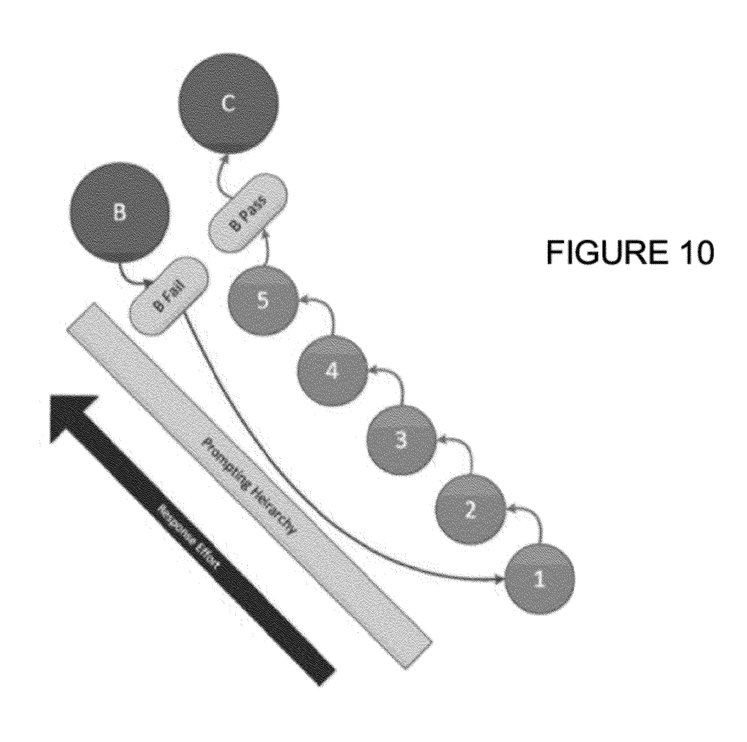

Variations of the above may also be used. For example, in FIG. 10 most-to-least prompting is illustrated. In this case, if the child fails to pass the initial test (at stage B), the game reverts to a least difficult prompt (at 1) for the stage and proceeds sequentially through a hierarchy of prompt difficulties (1 through 5) until mastery is achieved and the child moves on to the next stage (at C).

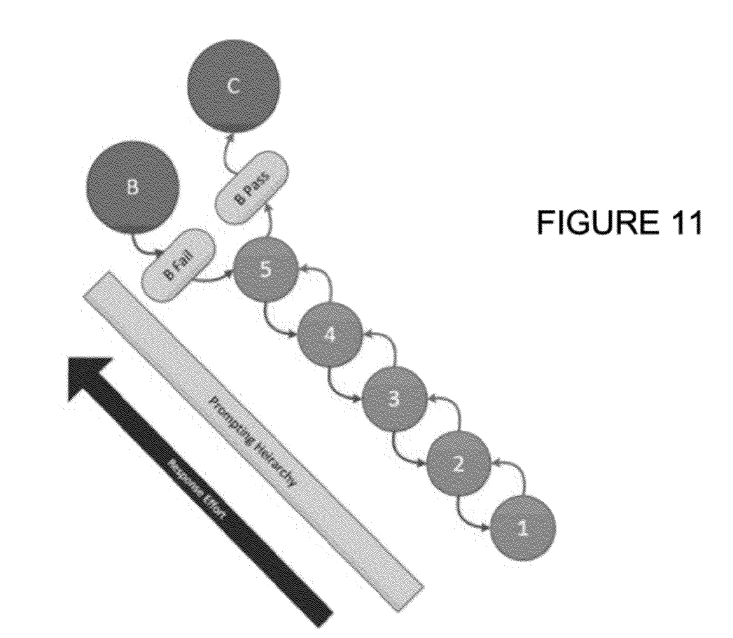

FIG. 11 illustrates an alternative example in which least to most prompting is used. Here, if the child fails the initial test (at stage B), the game reverts to the next most difficult prompt (at 5) for the stage and the child is allowed to try again. If the child fails, the game provides a next most difficult prompt (at 4), and so on until successive failures lead to the use of a least difficult prompt (at 1) for the stage. At anywhere along this progression, if the child answers correctly, the game then employs the next more difficult prompt, thus ensuring that the least number of prompts is used at a given stage of the game. Upon mastery, the game moves on to stage C.

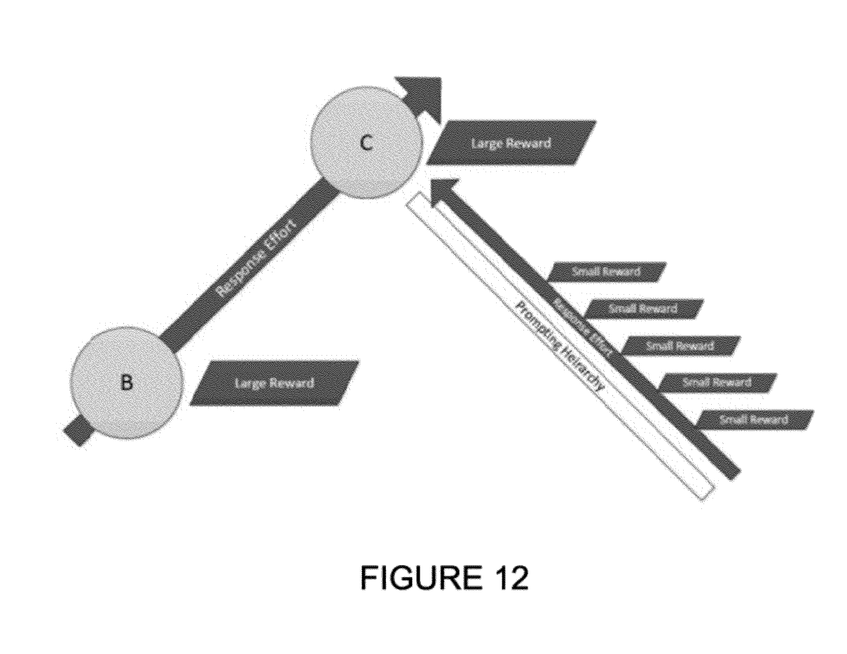

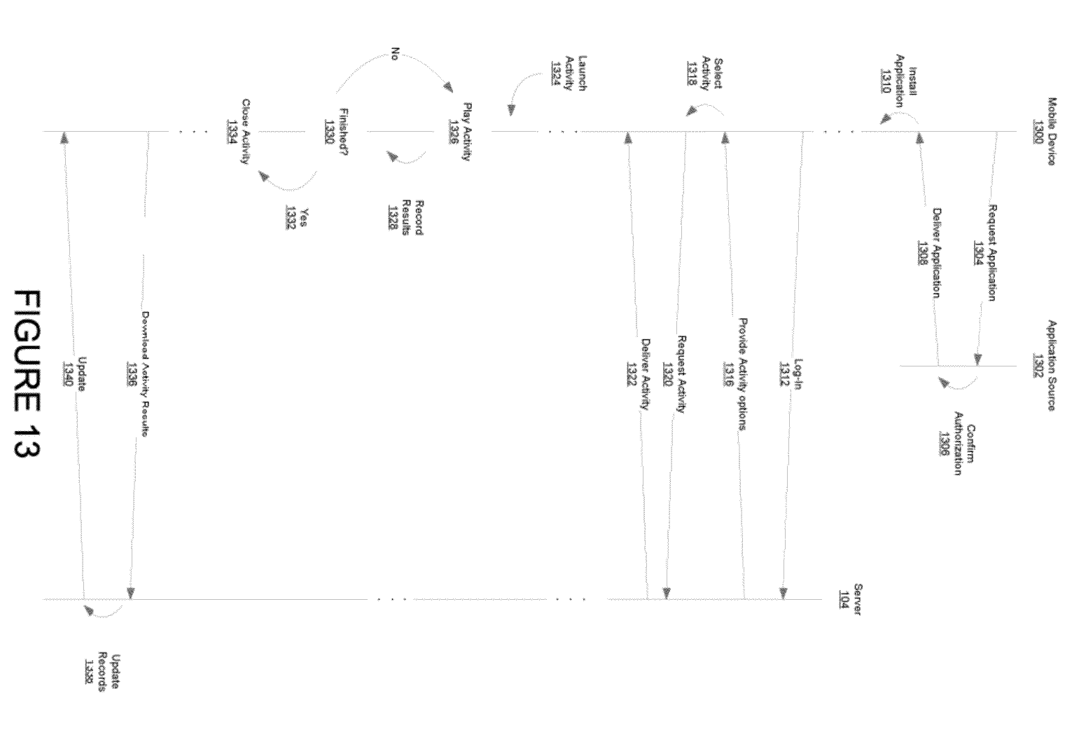

As shown in FIG. 12, rewards may be offered the child at various stages/prompt levels; large rewards for successful completion of stages and individual smaller rewards for successful answers to prompts at different levels of complexity within an overall stage. Rewards may differ depending upon many criteria, for example, the kind of game/skill to be developed, the age of the child, and other factors. Rewards may include unlocking of game features, as is common in the context of user interactive games.

Games to be provided to users in the context of the present invention may involve many considerations. For example, variations of the kinds, character and timing of stimulus presented, the ability for the user to specify some or all of the options (e.g., choosing a task from an array of tasks), and so on. In some instances, responses (i.e., their content and/or correctness) may be determined not only from (or not at all from) manual inputs, but from visual inputs as well. Consider, for example, that many tablet devices, smart phones and the like are now equipped with cameras that can capture images of the user as the user is engaged with the device. Such a camera (or other imaging apparatus of the mobile device) may be used by a game to capture images of the child as he/she is playing and, using suitable facial expression recognition software that executes either on the mobile device and/or on the server or other remote system, such images may be used as an input to the game. In the case where the facial expression recognition software executes (either wholly or in part) on the server or other remote system, the images captured by the mobile device would need to be transmitted back to the server/remote system for analysis (e.g., determination of their content and/or correctness). This may only be suitable where a sufficient broadband communication connection between the mobile device and the server is present.

By using facial expression recognition as an input, the present invention allows users with physical disabilities that do not allow them to touch objects on a screen to participate. Even if a user is not physically disabled, capturing facial expressions and using them as a tool to evaluate a user's emotional state (e.g., happy and engaged or remote and distant) can aid in scoring and assessing the user's current development. For example, a user may be taking long periods of time to respond to prompts, which may usually be indicative of the user having difficulty with the associated task. However, if facial expression recognition reveals that the user is bored and is not engaged with the game on a full time basis, the opposite may be true. The user may in fact have mastered the skill and have lost focus due to the dull nature of the activity.

Facial expressions may also be used as the basis for determining content or correctness of responses (e.g., if a child is instructed to smile, capturing an image of the child's face and analyzing the image to determine if the child is smiling may allow for automated assessment of the child's mastery of this task). Likewise, other interactions with the game platform (e.g., tilting, spinning, etc. of the mobile device) may also be used as a basis for determining content and/or correctness responses to prompts.

In addition to, or in place of, capturing facial expressions as input, the imaging apparatus of the mobile device may be used to capture images of gestures made by the child. Such gestures may be deemed responses to the stimuli provided by the game application or may be ancillary thereto. In either instance, by analyzing such gestures, at the mobile device, remotely therefrom (e.g., at the server), or both, further insight may be gained regarding the child's interaction with the application, mastery of the target skills, and overall development. Of course, other gestures, such as those commonly employed with touch screens to interact with information being presented on tablet computer devices, may also be captured and used as inputs for any or all of these purposes.

In some instances, the application installed on the mobile device may include a “pre-test” portion. This may be a version of the game, or another testing routine, that is intended to interact with the child and score the child's current level of development. The score so recorded may be used as a basis for determining a level to start the game activity at—i.e., a level appropriate to the child's current developmental level.

Further, the application may include a tutorial that teaches the child how the game is played, and how the child can “win”. This tutorial may provide instruction as to how the child should interact with the game and any other instructions deemed necessary before the child actually commences play. In some instances, the instructions will be for an educator or therapist instead of, or in addition to, the child.

The application may also include a “final test” or other portion which is intended to test the child on the skills that were to have been developed during the playing of the game. The test score may be recorded and reported to the server in the manner contemplated herein to allow for assessment of the child's developmental progress. In some cases the test may be administered with prompts while in other cases no prompts are provided. Various scores for different testing conditions (e.g., with/without prompts and/or tutors), testing dates, etc. may all be collected by the sever and used to assess the child's progress.

The test assessments and other statistics gathered by the application(s) and reported to the server may be used as the basis for one or more reports, such as IEP reports. Statistical or other information may be aggregated across multiple students and used for reports to government agencies, school boards, teachers, parents and the like. Such data may be annonomized prior to being distributed to preserve student confidentiality.

The games and other activities for use in conjunction with the present invention may have either or both behavioral and/or measurable objectives. A variety of different games (apps) may be used to assess and address adaptive skills, cogitative skills, language skills, mathematics skills, emotional development, and social skills. Other areas of development may be addressed as well.

FIG. 13 illustrates one example of a process by which a mobile application of the kind described herein can be obtained and used. Shown in the illustration are the interactions between a mobile device 1300 (e.g., a smart phone, tablet computer, etc.), a source of the application 1302 (e.g., the App Store™ or another third party source or, in some cases, server 104), and server 104, which hosts the computer-based system for child development assessment and treatment plan development, as described in the above-cited U.S. Patent Application. At 1304, the mobile device requests the download of the application and, upon confirming the device/user is authorized to receive it, 1306, the application is so delivered by the source to the mobile device 1308. Although not shown in detail, it should be appreciated that in some instances the application may be delivered after the mobile device is referred to the application source from server 104. For example, a web browser running on mobile device 1300 may be used to access a web page hosted at server 104, which web page may contain a link or other referring means to the application source 1302, from which the mobile device may download the application.

The application downloaded by mobile device 1300 may be customized for a single activity or a set of activities, or may be a more general application that serves as a player for activities obtained from server 104 or another source. For example, as shown in FIG. 13, once the application has been downloaded and installed 1310 to mobile device 1300, the user may launch the application and contact the server 104. If this is the first time the user is contacting the server, a registration process may be required (not shown). The registration may consist of establishing access credentials (e.g., a user name and password), which can be used for later accesses. In addition, a user may be asked to provide information about the subject individual for which the activities are to be provided. This may or may not include a full developmental assessment as described in the above-cited U.S. Patent Application, or portions thereof Alternatively, the assessment may be conducted in a separate session when the user creates an account with the system. In some cases, the assessment may be an abbreviated version of a complete assessment, for example focused on particular skills or disabilities which the users wishes to address with the subject child.

Where the user completes an assessment of some kind, whether full of otherwise, the system will provide a recommended treatment plan along the lines discussed in the above-reference U.S. Patent Application. Thus, when logging-in to an account 1312, and upon proper authentication 1314, the user may be offered a selection of activities for lessons appropriate to the treatment plan 1316. In still other instances, the user may be offered an a la carte menu of the activities from which to choose (e.g., in cases where no assessment was done and so no formal treatment plan exists). In response, the user makes a selection 1316, and sends a request for the selected activity 1320. The activity (i.e., content representing the activity for the application player) is then delivered by the server 1322.

In some cases, the user will be permitted to download only activities appropriate to a subject child's state of development as reflected in the child's progress within the treatment plan. For example, activities may be made available for download in a sequential or other fashion that takes into account such developmental progress. As discussed below, the progress is monitored through reports received from the mobile device concerning the child's progress in mastering skills that are the targets of the activities. Parents, care givers and others can monitor such progress by accessing the appropriate account at server 104, as discussed in greater detail in the above-referenced U.S. Patent Application.

As indicated above, the activity content will vary depending upon the skill being targeted. It may include audio-video presentation, instructions for therapists, and/or games for the subject child to play. Accordingly, the application player may have different modes of operation, for example a therapist mode where the player plays activity content suitable for use by a therapist when working with the subject child, and a game mode where the application acts as a proxy for the therapist and interacts directly with the subject child.

As illustrated in FIG. 13, some time after the activity has been downloaded to the mobile device, it is launched 1324, and interaction between the child and the mobile device (or between the child and the therapist using the mobile device) takes place 1326. During this time, the child's results are recorded 1328 and stored for later delivery to the server 104. For example, if the child is playing the game mode, data concerning the child's success in mastering the skills that are the subject of the activity are recorded (e.g., number of correct answers, identification of correct answers, time to complete activities, etc.). On the other hand, if the therapist is conducting the session, the therapist may indicate the child's progress, for example in response to questions prompted by the activity or otherwise. This continues until the activity is complete 1330 and the activity is closed 1334.

Sometime after the activity has been completed, the mobile device 1300 (i.e., the application running thereon) contacts the server 104 and downloads the activity results that have been stored. This may be done as part of a session designed for such purpose or as an opportunistic event the next time the user logs-in to the account. Regardless of when this information is delivered, the application running at server 104 uses the information to update the subject child's records 1338 and communicates any necessary information back to the application at the mobile device 1340. With the child's records so updated, the next time the user logs-in, he/she may be presented new activities for download, according to the child's progress (or lack thereof) towards mastering target skills.

In the above discussion, it was assumed that the application downloaded to the mobile device is a player for various activities. In other instances, the application and the activities are one in the same; that is, each activity is it's own self-contained application that can be downloaded to the mobile device. The process for downloading and using a self-contained application is similar to that described above, except that it is not necessary to load any additional activity content to the application. New applications may be made available, as skills that are the targets of completed applications have been mastered.

As mentioned above, the child's development progress may be monitored from the records stored by server 104. Progress charts and similar information may be viewed through a session with server 104 or downloaded to the mobile device (e.g., as a secure file for viewing only by an authorized user that presents the appropriate credentials). Together with the above-described applications and activities, this facilitates the monitoring of a subject child's mastered and non-mastered skills, determining a set of lessons from a specialized curriculum, which lessons define an individualized, ABA-based program of instruction (e.g., based on the needs of the subject child as identified by the assessment), and monitoring of the child's progress as he/she progresses through the lessons of the individualized program under the guidance of parents, therapists and others.

Thus, computer-based methods and systems for providing individuals access to automatically generated and individualized ABA-based programs of instruction based on the needs of children with developmental disorders, where such access is provided via applications deployed to mobile computing platforms (e.g., smart phones, table computers, and the like), have been described. As has been noted above, embodiments of the present invention may be implemented with the aid of computer-implemented processes or methods (a.k.a. programs or routines). These processes may be rendered in any computer-readable language. Further, one of ordinary skill in the art will immediately appreciate that the invention can be practiced with computer system configurations other than those described above, including hand-held devices, multiprocessor systems, microprocessor-based or programmable consumer electronics, digital signal processor-based devices, personal computers, etc. The invention can also be practiced in distributed computing environments where tasks are performed by remote processing devices that are linked through a communications network. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

What is claimed is:

1. A computer-implemented method, comprising:
downloading to a mobile device, an application for teaching and assessing a target skill of a developmentally disabled individual, said application having been determined according to a therapy plan individualized for the individual, the application including applied behavior analysis (ABA)-based activities for completion by the individual;
responsive to interaction involving the individual and the application running on the mobile device, recording information indicative of the subject individual's mastery of the target skill; and
uploading the information to a server hosting an instantiation of a computer-based system for assessment and development of individualized treatment plans for developmentally disabled individuals.

2. The computer-implemented method of claim 2, further comprising providing further applications for download to the mobile device according to progress of the individual through mastery of skills addressed by lessons of the treatment plan.

3. The computer-implemented method of claim 2, further comprising generating one or more reports concerning the individual's progress in mastering skills addressed by lessons of the treatment plan.

4. The computer-implemented method of claim 2, wherein the application comprises prompt-response colloquies for interaction with the individual.

5. The computer-implemented method of claim 1, wherein the application comprises an instructional program to teach a set of skills to the individual through introduction of a set of discriminative stimuli (S^{D}) and/or establishing operations (EO) intended to evoke behavioral responses in the individual.

6. The computer-implemented method of claim 1, wherein the application comprises a series of steps, each building off of a last successfully completed one of the steps in terms of its complexity and effort required of the individual to respond.

7. The computer-implemented method of claim 6, wherein the steps are taught using a most-to-least prompt methodology.

8. The computer-implemented method of claim 6, wherein the steps are taught using a least-to-most prompt methodology.

9. The computer-implemented method of claim 6, wherein the steps have associated rewards for the individual upon the individual's successful completion thereof.

10. The computer-implemented method of claim 1, wherein the application comprises stimuli to be presented to the individual for a response, and the application receives responses through images captured by an imaging apparatus associated with the mobile device.

11. The computer-implemented method of claim 10, further comprising the server analyzing the images captured by the imaging apparatus associated with the mobile device to determine content of the response.

12. The computer-implemented method of claim 1, wherein the application comprises stimuli to be presented to the individual for a response, and the application receives responses through interaction of the individual with the mobile device.

13. The computer-implemented method of claim 1, wherein the application comprises an assessment portion intended for use by the individual in order to determine the individual's present level of ability with respect to the target skill.

14. The computer-implemented method of claim 1, wherein the application includes a tutorial that provides instructions for interaction with the application.

15. The computer-implemented method of claim 1, wherein the application includes a testing portion for assessing the individual's level of ability with respect to the target skill after completing instruction provided through the application.

16. The computer-implemented method of claim 1, wherein the application includes a testing portion for assessing the individual's level of ability with respect to the target skill after completing instruction provided through the application.

17. The computer-implemented method of claim 1, wherein the application includes a one or more images rendered on the mobile device so as to simulate depth, thereby allowing for testing of the individual's motor skills.

18. The computer-implemented method of claim 1, wherein the interaction with the individual is assessed through images captured by the mobile device.

19. The computer-implemented method of claim 17, wherein the images are evaluated, at least in part, remotely from the mobile device.

20. The computer-implemented method of claim 17, wherein the images are assessed, at least in part, by the server.
